(19) United States
(12) Patent Application Publication
(10) Pub. No.: US 2005/0238891 A1
(43) Pub. Date: Oct. 27, 2005

(54) Wear resistant grinding machine components

(76) Inventors: Steven G. Smarsh, Harrison, MI (US); Toby L. Roll, Clinton Township, MI (US)

Correspondence Address: CARGILL & ASSOCIATES, P.L.L.C., 56 MACOMB PLACE, MT. CLEMENS, MI, 48043, US

(21) Appl. No.: 10/523,162

(22) PCT Filed: Aug. 1, 2003
(86) PCT No.: PCT/US03/24165

§ 371 Date: Jan. 27, 2005

Related U.S. Application Data
(60) Provisional application No. 60/400,090, filed on Aug. 1, 2002.
(60) Provisional application No. 60/447,059, filed on Feb. 13, 2003.
(60) Provisional application No. 60/447,061, filed on Feb. 13, 2003.
(60) Provisional application No. 60/452,032, filed on Mar. 4, 2003.

(51) Int. Cl. B32B 15/04

(52) U.S. Cl. 428/457; 428/698

(57) ABSTRACT

Various grinding machine components are made of superhard materials, including certain machine grade ceramics, including such materials as carbides, nitrides, borides, oxides, oxynitrides, or any other ceramic component. The component may either be a solid piece of ceramic or wear resistant material, or may have an insert or a piece of the wear resistant material adhered to a metallic substrate base for use within the machine. Graded materials may also be used with a gradient from a 100% concentration of ceramic at one surface, and gradually changing into a 100% metal at the other surface, would be advantageous. These superhard materials overcome some of the previously experienced problems as they will hold closer tolerances and resist wear better than other materials.

### CROSS REFERENCES TO RELATED APPLICATIONS

This application claims the benefit of U.S. Provisional Application No. 60/400,090 filed on Aug. 1, 2002; No. 60/447,059 filed on Feb. 13, 2003; No. 60/447,061 filed on Feb. 13, 2003; and No. 60/452,032 filed on Mar. 4, 2003.

### BACKGROUND OF THE INVENTION

1. Field of the Invention

The present invention relates to grinding machine components, and especially relates to grinding components made of superhard materials. More particularly, the invention relates to tension rods, transfer ways, and spindles and spindle housings made of wear resistant superhard materials.

2. Description of the Prior Art

Conventional grinding machine components made of steel are well known in the art, including one of the most common types of stainless steel that includes machine grade tool steel. However, as grinding machines have become more and more complex, and are now more capable of extremely high precision grinding, the tolerances on those steel components have become increasingly closer and closer. In addition, it is increasingly important for a centerless grinding unit machine to be extremely accurate as well as simple to learn and set up for a grinding operation. For grinding unit machines that are highly accurate work holding devices, with 0.000030″ standard repeatabillty, as well as for those optional machines with 0.000005″ to 0.000010″ repeatability, it is important for the grinding machine components themselves to be very rigid and true to the shape. If the various components can have dimensions that are held to true, there is no need for an operator to indicate a work piece, which can save a lot of time on the job.

With regards to the spindles of centerless grinding machines, the conventional steel components become worn after continuous use. Grinding machine components that are in a wear-induced state will have lowered tolerances, and the tolerances of the resulting work pieces will become lower and lower until the work pieces will become unusable. At that time, the grinding machine must be overhauled, and the originally specified tolerances will be once again achieved. However, in the very recent past, higher and higher tolerances are being required in order to maintain quality control standards for manufacturing processes under ISO 9001 procedures. Manufacturing capabilities also require less down time for manufacturing processes in order to maintain profits and jobs for the shop where the machine resides.

In an effort to maintain high tolerances for such grinding machines, it is important that wear-resistant machine tool components be utilized. It would therefore an advantage for the usage of wear-resistant grinding machine tool components which will not wear, and thereby keep the extremely high tolerance of the grinding machine even after the manufacture of large numbers of machine parts.

Others have tried in the past to make more wear resistant grinding components, but none have been able to make such highly precise and wear resistant components for this application, especially of the materials being proposed in the present invention. Practitioners of those prior art inventions have become aware of certain problems which are presented. One particular problem that has plagued operators has been that utilizing harder materials that will resist wear is more difficult to grind, especially to the desired tolerances sought by the present inventors. There are complexities which give rise to warpage and having a component that is out of true due to expansion and contraction.

Therefore, it would be of a great advantage to the grinding machine industry if there was provided various wear resistant grinding machine components made of superhard ceramic materials for holding close tolerances for a long time during operation, thereby reducing downtime, and saving costs.

### SUMMARY OF THE INVENTION

In accordance with the above-noted advantages and desires of the industry, the present invention provides various grinding machine components made of superhard materials, including certain machine grade ceramics, including such materials as carbides, nitrides, borides, oxides, oxynitrides, or any other ceramic component. The component may either be a solid piece of ceramic or wear resistant material, or may have an insert or a piece of the wear resistant material adhered to a metallic substrate base for use within the machine. In that same regard, it is also envisioned by the present inventors that cermets, materials which have a gradient from a 100% concentration of ceramic at one surface, and gradually changing into a 100% metal at the other surface, would be advantageous. Other cermets include ceramic infrastructures, infiltrated by molten metals, yielding a combination of ceramic and metal in the same piece of material. Furthermore, coatings of carbides, nitrides and the like, as described above, may be utilized to effectively coat a metal substrate, thereby giving a wear resistant coating. These superhard materials overcome some of the aforementioned problems with the prior art because they will hold closer tolerances and resist wear better than other materials.

The invention is particularly useful for applications of wear resistant transfer ways, tension rods, spindles and spindle housings, among other applications. Although the invention will be described by way of examples hereinbelow for specific embodiments having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different embodiments and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various embodiments of the present invention, reference shall be made to the following detailed description, and when taken in conjunction with the accompanying drawings, in which like parts are given the same reference numerals, and wherein;

FIG. 1 is a side elevational view of a grinding machine made in accordance with the present invention;

FIG. 2 illustrates a perspective view of a tension rod;

FIG. 3 is a perspective view a grinding rod made in accordance with the present invention;

FIG. 4 is a perspective view of a carbide pivot rod;

FIG. 5 is a top plan view of the grinding machine;

FIG. 6 is a bottom plan view of the grinding machine;

FIG. 7A is a side elevational view of the transfer ways in the grinding machine;

FIG. 7B is a side cutaway view of the transfer ways;

FIG. 8A is a bottom plan view of the transfer ways;

FIG. 8B is a side cutaway view of the transfer way;

FIG. 9 is a top plan view of the way;

FIG. 10 is a carbide pivot rod;

FIG. 11 is a perspective view of a pivot rod;

FIG. 12 is a side elevational view of the pivot rod of FIG. 11;

FIG. 13 is an exploded side view of the pivot rod of FIG. 11;

FIG. 14 is a perspective view of a rod;

FIG. 15 is a side elevational view of the rod of FIG. 14;

FIG. 16 is a perspective view of a threaded shaft rod;

FIG. 17 is a side elevational view of the threaded shaft rod of FIG. 16;

FIG. 18 is a perspective view of a concentric shaft seal;

FIG. 19 is a threaded seal;

FIG. 20 is a side perspective view of a portion of a grinding machine illustrating the relative placement of the spindle housing; and

FIG. 21 is a side perspective view of a portion of a grinding machine illustrating the relative placement of another embodiment of the spindle housing.

### DETAILED DESCRIPTION OF THE INVENTION

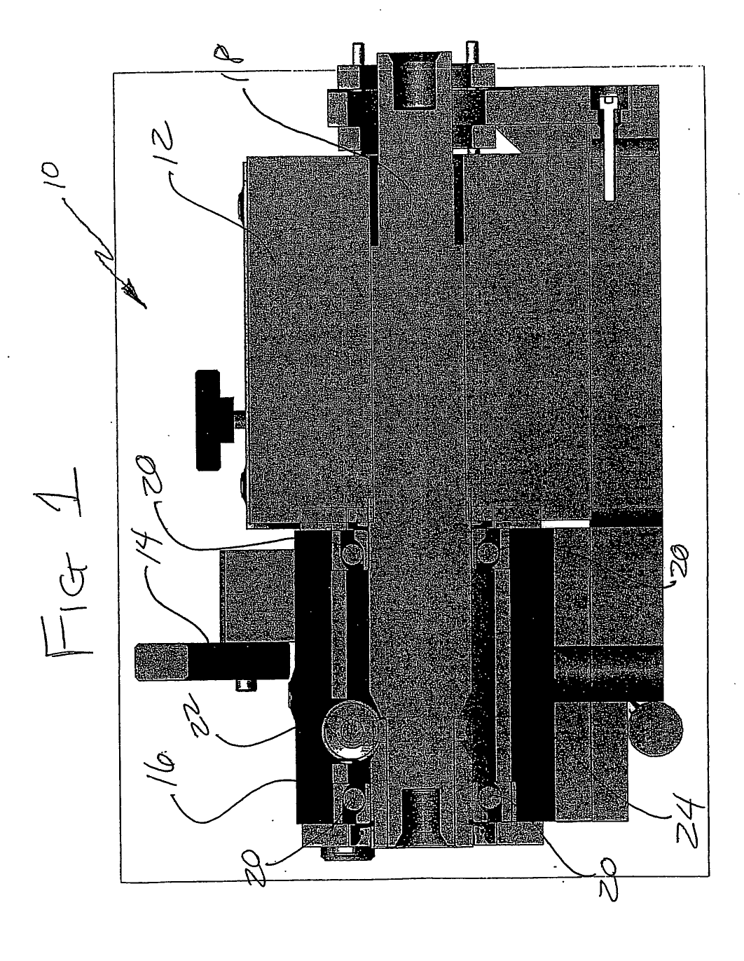

In accordance with the present invention, and in meeting and exceeding the objects and advantages being sought herewith, we now look to the appended drawings as illustrated in FIGS. 1-21 to more clearly define and state the invention. Looking first to FIG. 1, there is shown a grinding unit generally denoted by the numeral 10, which includes a regulating roller 12 surrounding a spindle 18. The regulating roller 12 receives the spindle 18 therethrough, and is rotatably mounted around the spindle by bearings 20. Bearings 20 are held against the unit body 16 by a tension arm 14.

A cross-sectional view of drive screw 22 is shown, and drive screw 22 rotates about its longitudinal axis to operate drive gear 24, also shown in cross-sectional view in FIG. 1. As can be seen in FIG. 1, the spindle 18 needs to be made of a rigid, non-flexing material to more carefully and precisely hold the tolerance for the regulating roller 12. As the drive screw 22 rotates and operates drive gear 24, spindle 18 rotates regulating roller, and is preferably rigid enough to hold the tolerances of the regulating wheel 12 during the dressing operation, which then (in turn) determines the repeatability of the grinding operation itself when the grinding wheel grinds the work piece.

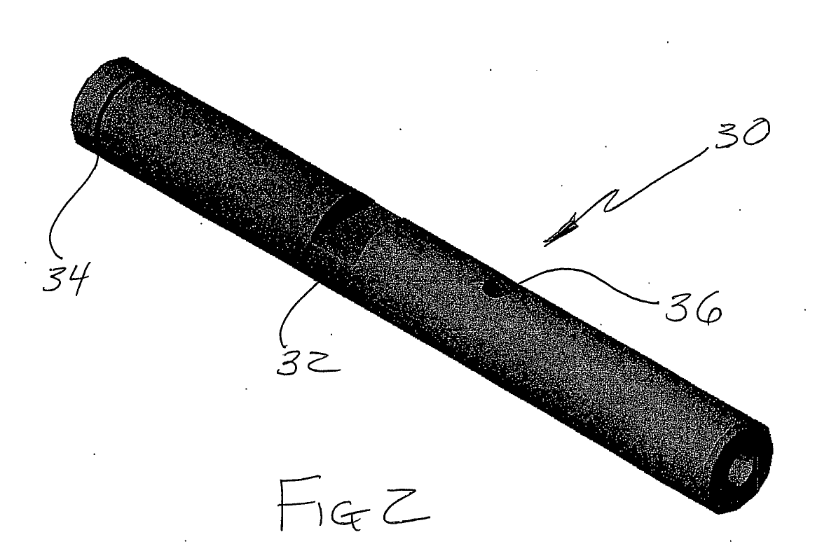

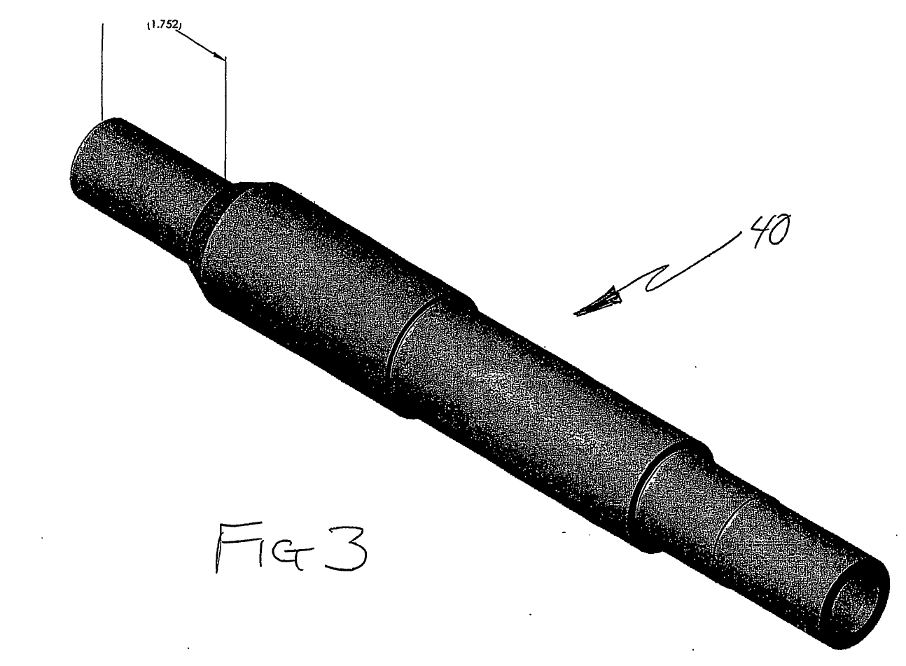

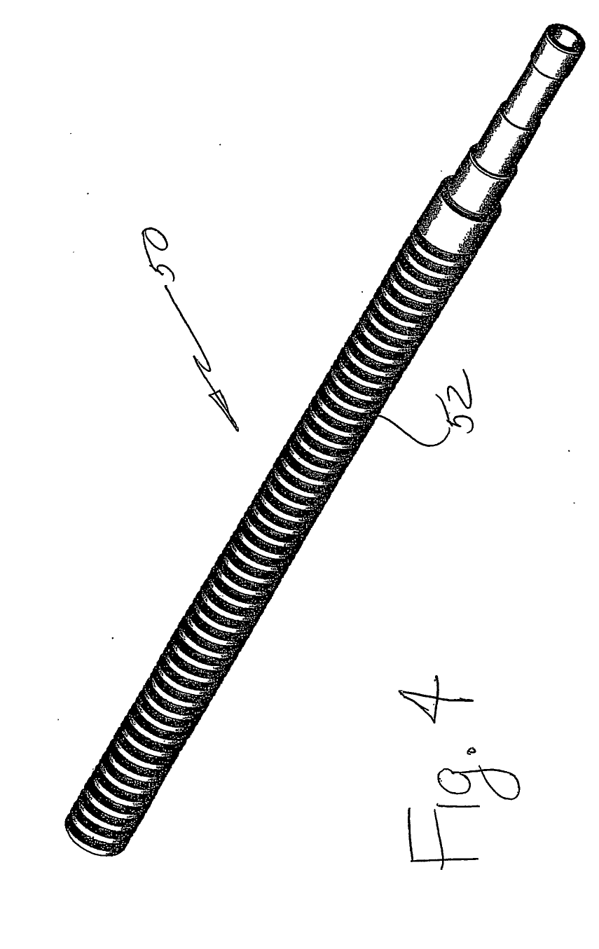

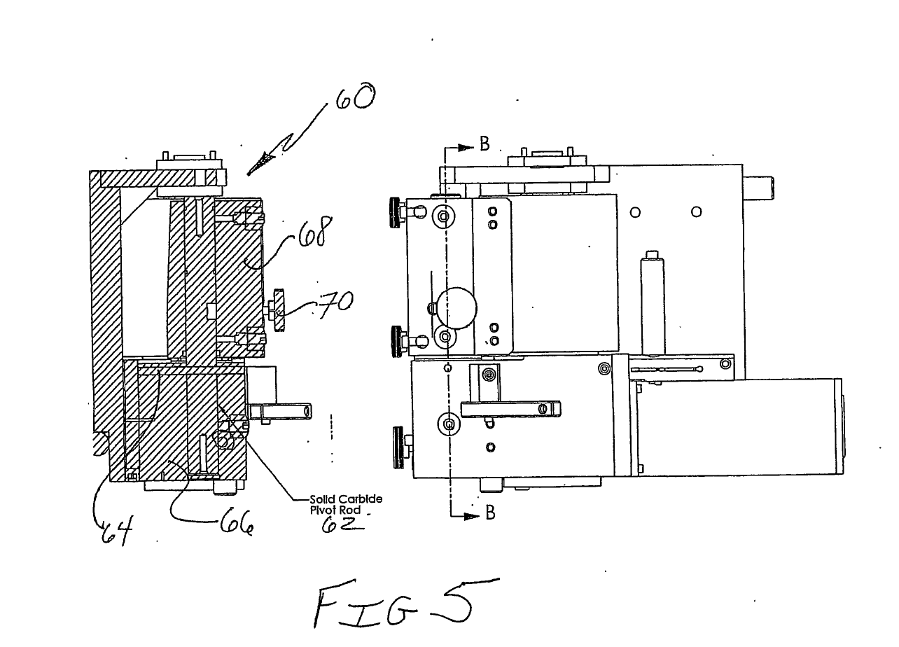

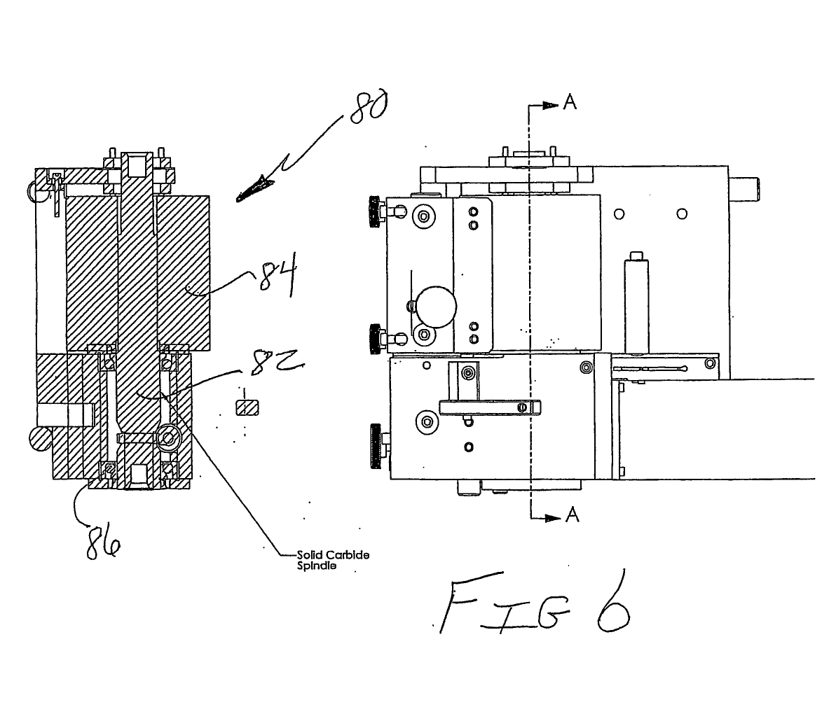

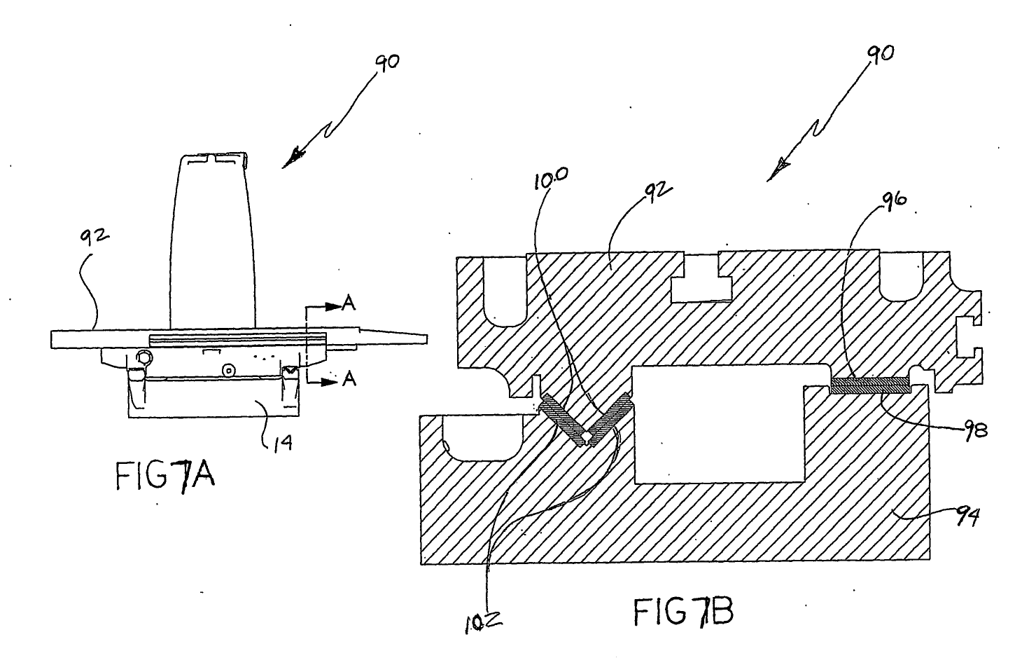

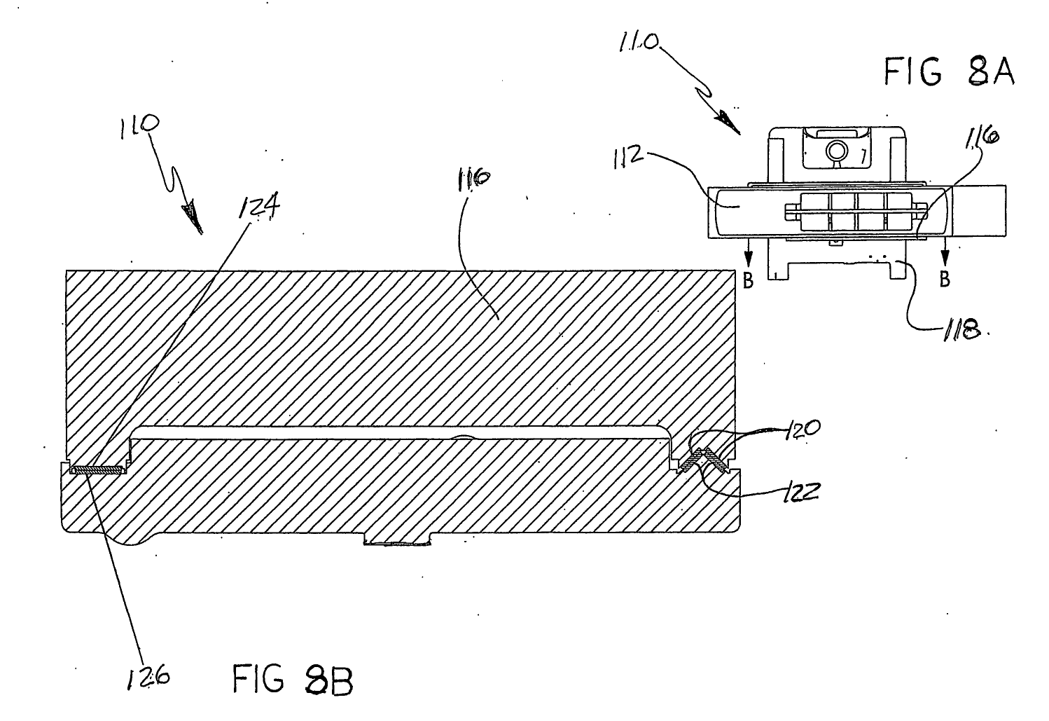

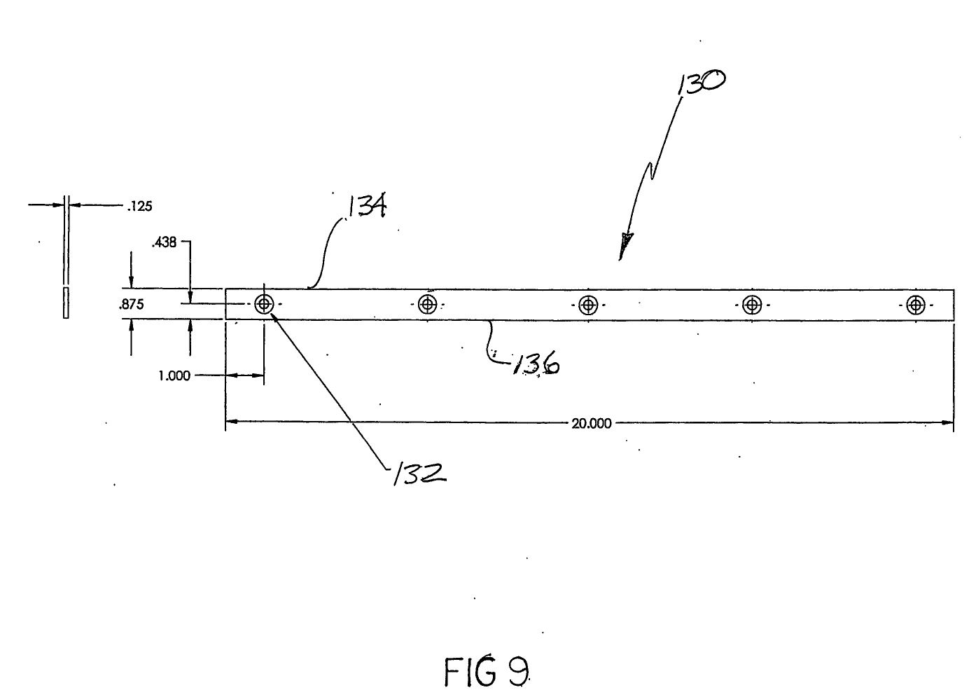

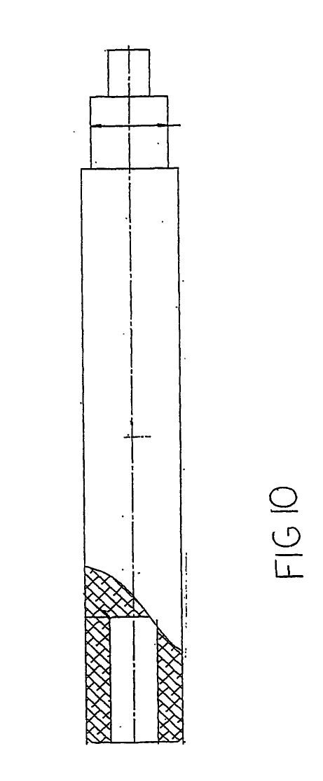

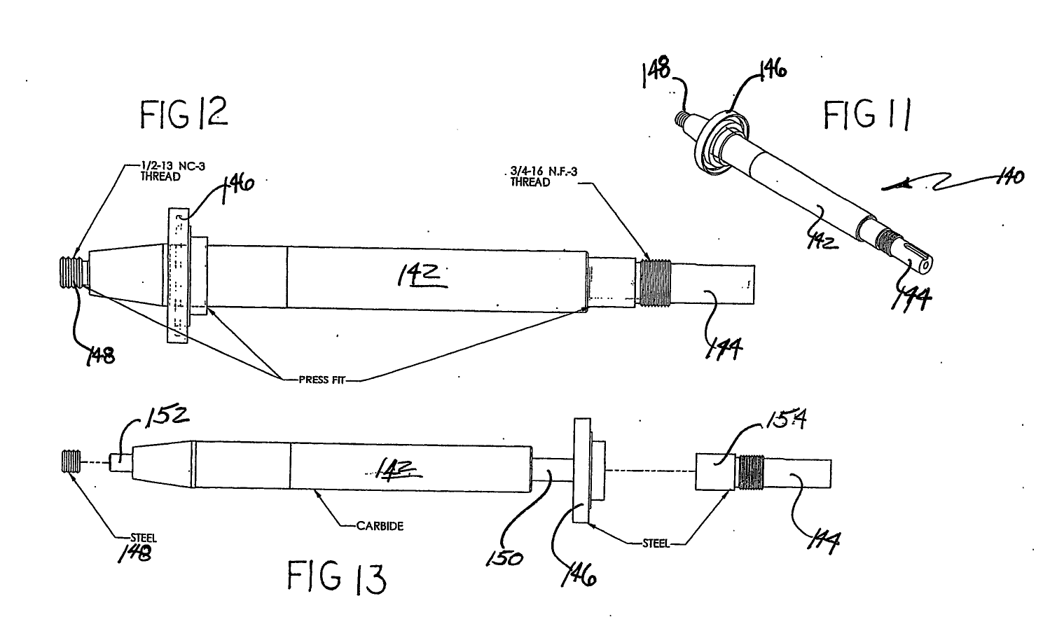

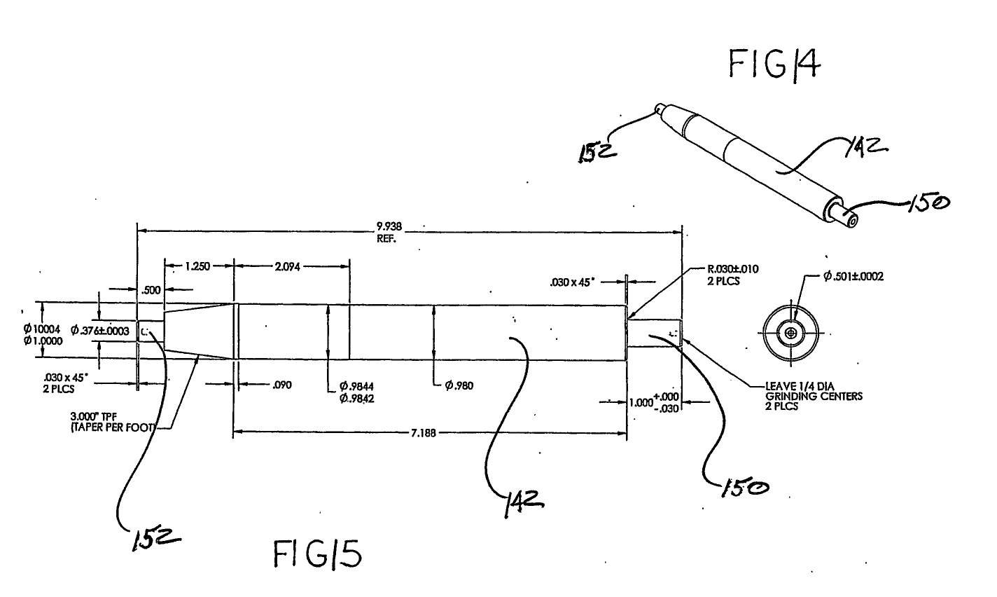

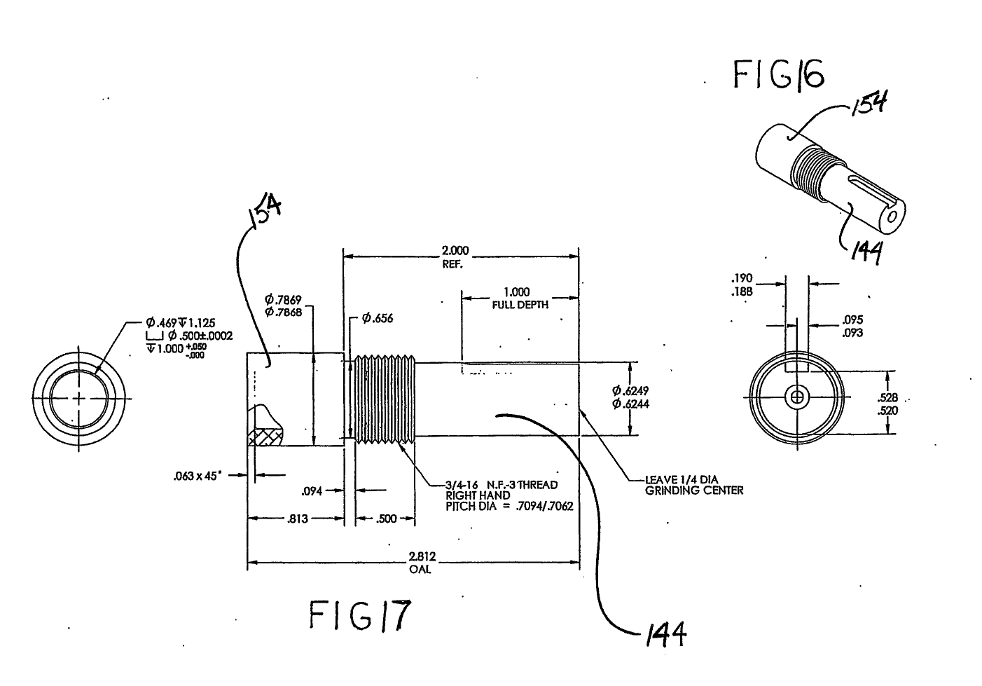

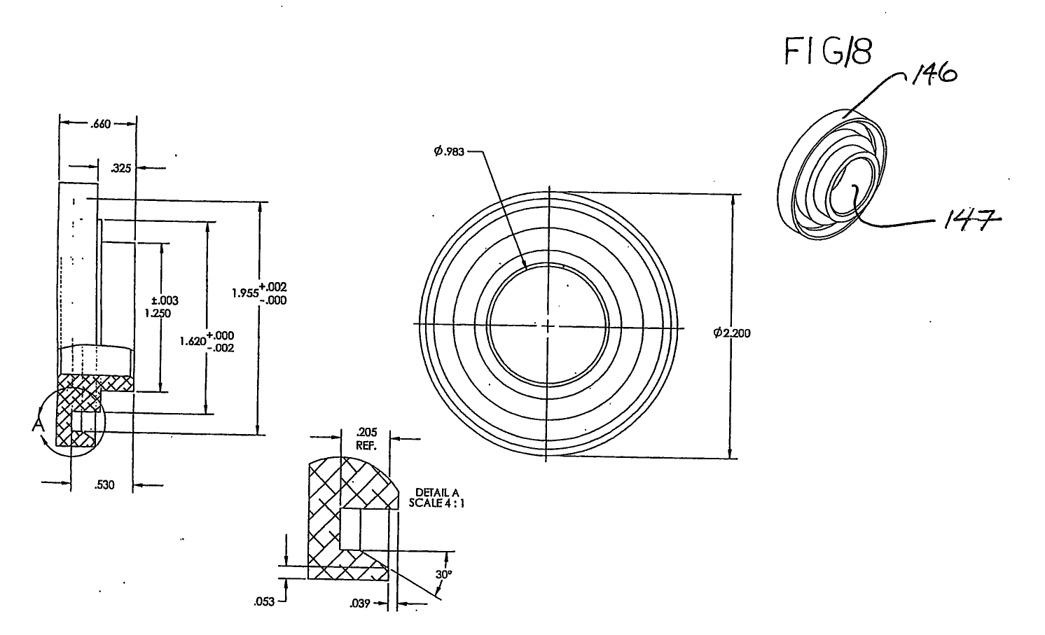

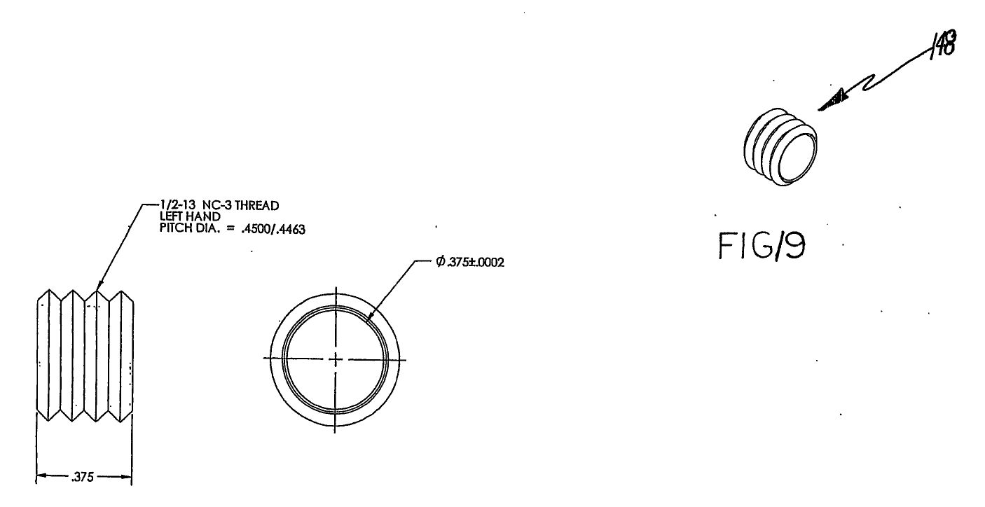

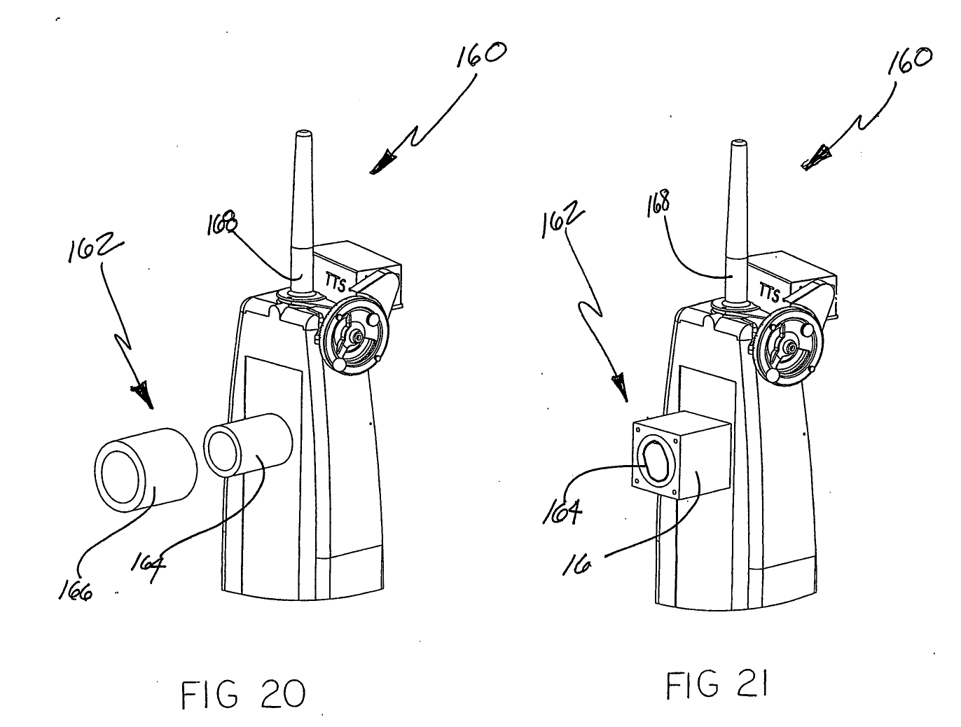

Looking next to FIG. 2, a pivot rod is generally denoted by the numeral 30, and is a round cylindrical grinding machine component having a locking slot 32 and a retaining ring groove 34 cut thereinto. A pivot pin hole 36 is drilled through the pivot rod 30. Pivot rod 30 will be described more fully hereinbelow with reference to other drawings.

FIG. 3 illustrates a precision ground spindle made in accordance with the present invention, and illustrates the preferred ground angles and outer diameter dimensions for use with a high precision grinder as that available from Tru Tech Systems, Inc., of Mt. Clemens, Mich. The spindle is more fully described hereinabove with reference to FIG. 1, and the materials useful for the spindle preferably include tungsten carbide, but may also utilize the materials listed hereinbelow, and may be done so without undue experimentation on the part of one of ordinary skill in the art in the act of reproducing the present invention.

FIG. 4 is a perspective view of a high precision lead screw made in accordance with the present invention, and is generally denoted by the numeral 50, including ground Acme threads 52 ground thereinto. Making the lead screw out of a super hard, rigid material is advantageous because it is this screw which drives the rollers, and will ultimately determine the repeatability of the grinding unit itself.

In other words, the three components illustrated in FIGS. 2, 3 and 4, i.e. the pivot rod, the spindle and the lead screw, respectively, are all components of a high precision grinding machine which will benefit greatly by being manufactured of extremely rigid, super hard materials, as discussed below. By manufacturing each of these components, as well as other components which will hold the tolerances of the grinding unit itself out of an extremely rigid material, such as tungsten carbide, the grinding machine will ultimately be able to grind work pieces to less than a millionth of an inch. If these components are made out of any materials that can flex or bend at all, the tolerances will be lost, and the dream of grinding work pieces to a millionth of an inch, reliably and repeatably, dissolves away with the flexing/bending of these various components. The spindle, being made of carbide, will essentially not flex, and will hold the regulating roller in proper position so that the dressing operation can be close to perfect. When the pivot rod is made of super rigid materials, the blade is held in perfect position, yielding a greater repeatability at higher tolerances than those which were available to a grinding operator before.

Turning now to FIG. 5, there is shown a grinding unit 60, including a pivot rod 62 held in place with a pivot pin 64. Grinding unit body 66 acts as a securement for the pivot rod 62, and is held in place with pivot pin 64, also shown in FIG. 2 above. Blade holder 68 is shown as being held against the pivot rod 62 by locking screw 70. The pivot rod is made of a super rigid and super hard material as described below with reference to the preferred materials utilizable for all the grinding machine components envisioned by the present inventor.

Looking last at FIG. 6, there is shown a grinding unit 80, showing the relative placement of spindle 82 with regards to the regulating roller 84 and bearings 86. The operation of the spindle has already been described above with reference to FIG. 1, and similar principles apply. The spindle is preferably made of tungsten carbide or any of the other materials listed below. Any substitution of the materials may be done without undue experimentation on the part of one of ordinary skill in the art practicing the present invention.

Looking now to the materials suitable and advantageous in accordance with the present invention, the inventor contemplates useful rigid grinding machine components made of any super hard material, including, but not limited to, carbides, nitrides, oxides, borides, ceramics, cermets, carbonitrides, carbon diffused materials, including steel, nitrides, borides, oxides, other metals and surface treated ferrous compounds. All the preferred compositions listed herein are useful for the present invention, although some are more preferred than others. It is also envisioned by the present inventor that carburized steel is useful, and that rigidity enhancing treatments prove useful. Such rigidity enhancing treatments can include quenching (to produce a martensitic or bainitic case around a carburized steel part), reheating (for controlling and reducing the surface carbon content below the saturation level), cold treating, and tempering.

Especially suitable materials for all the above-described grinding machine components include all rigid ceramics made of carbides, nitrides, borides, oxides, carbonitrides, borocarbides, boronitrides, nitroborides, and especially tungsten carbide (WC), titanium carbide (TiC), combinations of WC and TiC and all other carbides, as well as other nitrides including carbonitrides (CN), silicon nitride (Si₃N₄), silicon carbide (SiC), and all other nitrides and nitro-carbides. Super hard materials also useful for the present invention include borides, such as boron carbide and other borides and boron nitride compositions. Of particular interest, and encompassing the preferred embodiment of the present invention, the grinding machine components are preferably made of tungsten carbide and/or tungsten carbide alloys with other ceramic materials. The most preferred material for the present application is basic high-grade tungsten carbide, although the other materials listed are equally useful. They may not be as advantageous as they will be more difficult to machine into the grinding machine component, or the material may be more expensive than the tungsten carbide. Those factors aside, their rigidity will all pass the necessities for the present invention.

Superior grinding machine components made then from a group of super hard, extremely rigid materials that will ultimately increase the repeatability of the grinding machine because all the components will be held in position so rigidly, thereby keeping the tolerances of the grinding machine during operation. In addition, these components will be virtually wear proof for longer life of the grinding machine, and they will allow for fast and high stock removal in the bargain. Increased productivity and keeping higher tolerances is the desired result in the grinding industry, and the present invention will help achieve those goals.

Therefore, the present invention discloses superior grinding machine components made from a group of super hard, extremely rigid materials that will ultimately increase the repeatability of the grinding machine because all the components will be held in position so rigidly, thereby keeping the tolerances of the grinding machine during operation. In addition, these components will be virtually wear proof for longer life of the grinding machine, and they will allow for fast and high stock removal in the bargain. Increased productivity and keeping higher tolerances is the desired result in the grinding industry, and the present invention will help achieve those goals. While the description of the suitable materials may appear to be directed toward only some of the components, the following description relates to all grinding machine components.

The present invention is preferably made of a bulk carbide, Grade 2 material, although it may be made of any other known ceramic. The ceramic may be of a commercial grade of purity, and may be machined utilizing some of the equipment further invented by the present inventors earlier, known as the Tru-Tech Grinding Machine. Further in an attempt to achieve the objective of the present invention, a production steel center tension rod can be coated with a ceramic material, or there may be an insert or sleeve placed around the tube of the tension rod. Clearly, because the objective of the present invention is to provide a wear resistant surface for the tension rod, any means of having the wear resistant material on the surface which is subject to the wear is of importance, including surface treatments such as carburizing or carbonitriding.

The present invention discloses the use of wear resistant materials for the use of tension rods, and may include such things as carbides, nitrides, borides, oxides, oxynitrides, or any other ceramic component. The component may either be a solid piece of ceramic or wear resistant material, or may have an insert or a piece of the wear resistant material adhered to a metallic substrate base for use within the machine. In that same regard, it is also envisioned by the present inventors that cermets, materials which have a gradient from a 100% concentration of ceramic at one surface, and gradually changing into a 100% metal at the other surface, would be advantageous. Other cermets include ceramic infrastructures, infiltrated by molten metals, yielding a combination of ceramic and metal in the same piece of material. Furthermore, coatings of carbides, nitrides and the like, as described above, may be utilized to effectively coat a metal substrate, thereby giving a wear resistant coating.

These ceramics may come in varying grades, such as the preferred carbide material, and especially of Grade 2 carbide. It would also be advantageous to incorporate cobalt or any other metallic component into the overall composition of the ceramic in percentages of from about 1 percent up to about 50 percent, both by weight. For example, the addition of cobalt metal into a carbide bulk material prior to grinding into a desired shape, such as the tension rod of the present invention, will help to prevent breakage in the event that the piece is ever dropped on the floor. Preferable amounts of cobalt are from about 1 to about 20 weight percent. Other metals may be desirable, including vanadium, chromium, manganese, nickel, copper, zinc, molybdenum, cadmium, indium or tin. Furthermore, magnetic components such as powdered iron, nibium, yttrium or other conventional permanent magnets may also be advantageously employed. These components would be most useful in the percent weight ranges of between about 1 and about 25 percent of the resulting weight.

Grades 1 through 5 of carbide are especially useful, although any other commercial or ultra pure grade of ceramic or carbide may be utilized within the scope of this invention. Of the carbides, the most preferred include tungsten carbide (WC), titanium carbide (TiC), or combinations thereof, or a boron carbide (BC). It is also envisioned that nitrides, including silicon nitride (Si₃N₄) or other carbonitrides may be useful in particular situations due to their lubricious characteristics. Self-lubricating ceramics may also be of a special help, and of those materials silicon nitride is especially preferred. In addition, various oxides, including alumina (Al₂O₃), or other oxides, or other oxynitrides, are useful.

In addition to the use of ceramics on the wear resistant surfaces of the tension rod, the present invention further envisions carburizing and carbonitriding for developing hard surfaces of steel parts, such as the tension rod. Although the basic principle of carburizing and carbonitriding have remained relatively unchanged through the years, there are many changes in the technology of metals which have made for changes in metallic structures, as well as their processing equipment, in order to achieve carburizing and carbonitriding. Generally, carburizing is effected by gas carburizing and hardening which will produce a hard surface layer on a ferrous alloy. When using carburizing, a hardening agent is introduced into the surface of the alloy steel, thereby modifying the composition of the surface layer material itself. Thereafter, appropriate heat treatment provides for a case hardened surface layer with a core interior. This is especially useful for austenitized ferrous material components which are brought into contact with an environment of sufficient carbon to cause absorption of the carbon at the surface and by heat diffusion creating a carbon concentration gradient between the surface and the interior or core of the metal component itself. Carburizing may be done in a gaseous atmosphere (gas carburizing), a salt bath (liquid carburizing), or pack carburized by placing all of the surfaces of the work piece in contact with a solid compound. Carbonitriding is done in a modified gas carburizing atmosphere, where the modification includes the introduction of ammonia into a standard gas carburizing atmosphere, thereby providing the appropriate nitrogen.

Within the carburizing procedure, free carbon is then absorbed into the surface layer of the work piece, which generally has a relatively low carbon content to begin with. The free carbon is derived either from its gaseous or liquid source which comes into intimate contact with the metal surface. Absorption of the carbon into the surface layer may set up a concentration gradient, and carbon atoms may move by diffusion away from the surface. Theoretically, then, the surface layer can attain a carbon content determined by the carbon potential, while the core will stay at a constant concentration of ferrous and other components. In most instances, the amount of carbon in the environment is controlled to achieve a desired carbon content at the surface of the metal.

With regards to carbonitriding, however, the requisite ammonia added to the gas carburizing atmosphere dissociates to produce hydrogen and monoatomic nitrogen. The nitrogen is then absorbed into the surface of the work piece, along with carbon from the carburizing gas. Generally, carbonitriding is most advantageous as it is used in making a shallow carbonitrided surface because the nitrogen inhibits the diffusion of carbon throughout the steel, although it enhances hardenability, which favors the attainment of a very hard case that is easily polished and highly wear resistant. In addition, nitrides are formed and the particular hardness of those nitrides leads to even more wear resistant than is attributable to a maximum matrix hardness alone.

However, it must be realized that the preferred material for the present invention is a carbide, which is a Grade 2 material. A stock piece will be machined into a desired shape to be used as a tension rod in a grinding machine application. Furthermore, in an attempt to provide a wear resistant surface as desired by the present invention, there are many heat treatments, quenching treatments and other surface effects which can be implemented in order to provide a more wear resistant surface for the tension rod. All of these treatments, or inclusions of ceramics and the like, are designed to do one thing . . . . to provide wear resistance for the tension rod so that it will hold its extremely high tolerances. The treatments that we are discussing do not add to the dimension of the particular grinding machine component, rather they are atomically absorbed into the bulk of the material and can be used interchangeably with production steel components for the grinding machine.

In addition to the above description of the use of ceramics and the use of surface treatments such as carburizing, carbonitriding and heat annealing or quenching, there are also various procedures for increasing the adhesion on the surface of a metal substrate to any of the above-mentioned wear resistant materials and/or treatments. In particular, pre-oxidation prior to any adhesion or to the subjection of gas carburizing provides a maximum carbon and nitrogen absorption and diffusion, based on thermodynamic and kinetic considerations. Furthermore, there may be additional layers of metal, such as nickel or tin, which can be plasma sprayed, sputtered, plasma discharged, or any other method of applying a very thin coating of an adhesion layer onto the steel core component prior to receiving the ceramic, or a gas treatment such as carburizing. Gas treatments, such as sulfonation, may also be employed to help adhesion of subsequent layers. In addition, ionic chemical treatments may also add to the adhesion factor, or may be utilized for surface hardened components. All of these hardened layers will provide a superior contact performance for rolling and sliding operations, and will provide better specifications and equipment considerations which are essential for reproducible process executions, including grinding of work pieces.

Looking now to FIGS. 7A and 7B, there can be seen in FIG. 7A a grinding machine generally denoted by numeral 90, having a work platform 12 positioned above a machine base 94. When taken along lines A-A, FIG. 7B shows a cutaway elevational view of the portion of the grinding machine which illustrates the relative placement of the ways. As shown in FIG. 7B, work platform 92 is positioned above machine base 94, and is separated by a pair of v-shaped ways and flat surface ways. Flat way top member 96 slides atop flat way bottom member 98. At the other end of the platform a v-shaped way top member 100 slides atop the v-shaped bottom member 102. As shown in these figures, any configuration of the wear resistant way members disclosed in the present invention may be utilized. This may include a solid carbide Grade 2 material way, or may include a cermet or a carbide insert placed over a metal substrate to be used in place of a metal way.

Looking next to FIGS. 8A and 8B, there is shown a top plan view of a grinding machine generally denoted by numeral 110 in FIG. 8A. The work slide 112 is slideably mounted onto the work base 118. The work platform slide 116 is best seen in FIG. 8B, and is slideably mounted on top of the work base 118. It is suspended by a flat way and a v-shaped way. The v-shaped way top member plate 120 slides atop the v-shaped way bottom member plate 122, while the flat way top member plate 124 slides on top of flat way bottom member plate 126.

With reference to FIG. 9, there is shown an insert made of the wear resistant material in accordance with the present invention, which may be used as a surface piece on top of a metal substrate of the way itself. FIG. 9 generally denotes a way insert by numeral 130, and includes a countersunk hole 132 within the bulk of the way insert 130. The way insert upper surface 134 and way insert lower surface 136 are ground smooth for sliding capabilities, in the instance of upper surface 134, and for proper adhesion with regards to lower surface 136 to an underlying substrate piece. The metal substrate is not shown in these figures, although the use of carbide inserts is common in certain industries.

Looking at FIG. 10, there is shown a side elevational view of a tension rod, suitable to be received by a tension rod arm (not shown). The tension rod is basically of a cylindrical structure and has a longitudinal axis down the center of the rod. The rod is preferably perfectly round, so as to impart a uniform force on the work piece as it is rolling around against the grinding wheel (also not shown). In the most preferred embodiment, the tension rod is a little more than 5½ inches long, with approximately a ¾ inch diameter. There is a hollow, machined-out portion which is approximately 1 inch and is about a third of an inch in diameter, in order to be received on the tension rod arm. Further, there are machined-out portions of the other end of the tension rod from the hollow end, and they are respectively about ½ inch and more than 1/4 inch, suitable for being received by other components in the grinding machine. Although the tension rod is currently being made from production steel, it is thought by the present inventors to be an advantage to provide a new tension rod material which is more wear resistant than the conventional steel pieces.

Looking now to FIG. 11, there is shown a spindle assembly for utilization in a grinding machine, and the spindle assembly is generally denoted by the numeral 140. Spindle assembly 140 includes a spindle shaft 142 with a threaded shaft 144 press fitted over a distal spindle extension on the distal end of spindle shaft 142. At the proximal end of the spindle shaft 142, there is a press fitted concentric collar 146 where the concentric collar 146 includes a concentric collar aperture 147 (shown in FIG. 18) through the center of collar 146 ready to be press fitted over a proximal spindle extension 152 which is integral with spindle shaft 142. A threaded tip 148 is press fitted onto proximal spindle extension 152 in order to complete the spindle assembly. As can be seen with combined reference to FIGS. 11 thru 13, it is envisioned by the inventors that the spindle shaft 142 may be made of the wear-resistant material, or may be coated with the wear-resistant material, such that other grinding machine components which turn regularly over the spindle shaft 142 will not wear down the surface and thereby reduce the tolerance of spindle shaft 142. Spindle shaft 142 is machined to form a desired shape and has a distal spindle extension 150 to receive a threaded shaft collar 154 which is integral with threaded shaft 144. Threaded shaft collar 154 and threaded shaft 144 are conventionally made of a machine grade tool, but may also be made of a wear-resistant material or a surface coated high strength core. Looking to the proximal end of spindle shaft 142, there is a proximal spindle extension 152 which has been machined and is also made of the wear-resistant material and or wear-resistant material coated over a steel core. A threaded tip 148 is press fitted over the proximal spindle extension, and adds great strength and usability to the spindle shaft itself.

Looking next to FIGS. 14 and 15, there are shown detailed drawings of the spindle shaft 142 itself, with the distal spindle extension 150 and proximal spindle extension 152 extending therefrom. Of course, different configurations for the spindle assembly itself may be utilized for different grinding machines, although this is a standard spindle shown in FIGS. 14 and 15.

Looking now to FIG. 16, there is shown the threaded shaft 144 with its integral threaded shaft collar 154. The collar 24 has an interior diameter which is of a particular shape, depth and wall thickness in order to be press fit over the distal spindle extension 150 shown in the previous FIGS. Although the threaded shaft 144 is preferably made of machine grade steel, threaded shaft 144 may also be made with a steel core, and have a wear-resistant surface created thereon in order to allow for wear-resistant usage of the grinding machine. A wear-resistant coating could be sputtered, discharged, plasma sprayed, or created on the surface of a steel component. Such techniques are known in the art for making titanium nitride coatings, and the like. Such a coated component would have a resulting high tolerance wear ratio.

FIG. 17 illustrates a side elevational view of a threaded shaft 144, having a grinding center and a smooth portion 154 at the distal end. The threaded portion is preferably a ¾ 16 N.F.-3 thread, right hand, with a pitch diameter of 0.7094 to a 0.7062.

Looking next to FIG. 18, there is shown a concentric collar 146 having a concentric collar aperture 147 extending axially through the collar 146 in a diameter sufficient to be press fit onto the spindle shaft 142 itself. In this particular embodiment, the concentric collar 146 has a specific shape and dimension, and is not to be limited in the scope of this invention by the particular embodiment shown in FIG. 18. Again, a high strength steel core may be utilized with a wear-resistant carbide, nitride or oxide coating or insert placed on or around the collar for wear-resistant itself.

FIG. 19 shows the threaded tip 148 which is to be press fitted onto the proximal spindle extension 152, in order to be complementary to other grinding machine components. It is preferable to have this component made of a high grade machine steel in order to impart strength onto the spindle shaft 142 when it is in use when the grinding machine application itself.

Therefore, in accordance with the present invention, there is disclosed a complete wear-resistant spindle assembly having a concentric collar press fit thereon along with a threaded shaft and threaded shaft collar which achieves the objectives and advantages of the present invention. Whether the wear-resistant feature is achieved via a bulk material which is generally wear-resistant, or whether a high strength steel core is utilized with a wear-resistant coating thereon, the prescribed spindle assembly as shown in FIGS. 11 thru 19 will achieve those objectives and maintain the tolerance of the grinding machine after many hours of operation.

Even though a particular embodiment of the spindle assembly has been shown in FIGS. 11 thru 19, it must be understood that the scope of the invention is not be limited by the exact configuration of the spindle assembly, rather conventional spindle assemblies utilized in traditional grinding machines may employ the present concept of this invention in order to maintain their tolerances and achieve better workability, more high tolerance work pieces resulting therefrom, and less down time in the machine itself.

FIGS. 20 and 21 are both illustrations of a spindle housing as part of a grinding machine in accordance with the present invention, and the grinding machine is generally denoted by the numeral 160. Grinding machine 160 includes a spindle housing generally denoted by the numeral 162, including a spindle housing arm 164 and a spindle housing sleeve 166 to be received by the spindle housing arm 164. FIGS. 20 and 21 are essentially the same, but they illustrate various embodiments of the spindle sleeve. FIG. 20 shows a round sleeve, while FIG. 21 shows a square housing.

The spindle housing of FIGS. 20 and 21 are advantageously made of the same materials as those described above. For the sake of brevity, that description will not be repeated here, but applies equally. One of the real advantages of the spindle housing being made of carbide or other ceramic materials is that the extra weight makes for a more stable machine, which helps to keep the tolerances higher for a longer period of time.

In summary, numerous benefits have been described which result from employing any or all of the concepts and the features of the various specific embodiments of the present invention, or those that are within the scope of the invention. The superhard materials act perfectly to resist wear and to provide a more repeatable grinding operation.

The foregoing description of a preferred embodiment of the invention has been presented for purposes of illustration and description. It is not intended to be to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated. It is intended that the scope of the invention be defined by the claims which are appended hereto.

### INDUSTRIAL APPLICABILITY

The present invention finds industrial applicability in the grinding machine industry.

1. A wear resistant grinding machine component, comprising:
a grinding machine component made of a solid ceramic ial selected from the group consisting of carbides, nitrides, oxides, borides, cermets, carbonitrides, and combinations thereof.

2. An extremely high precision wear resistant grinding machine component for a high precision centerless grinding machine, comprising:
a grinding machine component made of a solid piece of an extremely rigid and very hard, non-flexing material select from the group consisting of ceramics, carbides, nitrides, borides, oxides, oxynitrides, carbonitrides, alumina, cermets, nitrides, borides, oxides, and combinations thereof,
wherein the grinding machine component may include the entire component being made of a ceramic material, a sleeve of solid ceramic material adhered over a metallic substrate base, and a grinding machine component made of a cermet material, formed into a grinding machine component.

3. The grinding machine component of claim 1, wherein the grinding machine component is selected from the group consisting of tension rods, transfer ways, spindles, spindle housings, pivot rods, threaded shaft rods, concentric shaft seals, lead screws, and combinations thereof.

4. The grinding machine component of claim 1, wherein the grinding machine component is non-flexing and maintains a very high tolerance of from about 0.000005 inch to about 0.000030 inch.

5. The grinding machine component of claim 1, wherein the grinding machine component enables a repeatability factor of from about 0.000005 inch to about 0.000030 inch.

6. The grinding machine component of claim 1, wherein the grinding marine component is made of a metallically infiltrated cermet material made from a spongy ceramic and then infiltrated with a molten metal which is thereafter allowed to solidify within the matrix of the spongy ceramic.

7. The grinding machine component of claim 1, wherein the grinding machine component further includes a metallic component incorporated into the ceramic material to increase the strength of the component.

8. The grinding machine component of claim 7, wherein the grinding machine component further includes a metallic component in the ceramic material selected from the group consisting of cobalt, vanadium, chromium, manganese, nickel, copper, zinc molybdenum, cadmium, indium, tin and combinations thereof.

9. The grinding machine component of claim 7, wherein the grinding machine component further includes the metallic component in a concentration of from about 1 to about 50 percent by weight.

10. The grinding machine component of claim 1, wherein the ceramic grinding machine component further includes a magnetic component including a component selected from the group consisting of powdered iron, niobium, yttrium and combinations thereof.

11. The grinding machine component of claim 10, wherein the grinding machine component further includes the magnetic component in a concentration of from about 1 to about 25 percent by weight.

12. The grinding machine component of claim 1, wherein the grinding machine component may be formed into a grinding machine component by forming a hard surface layer by a method selected from the group consisting of carburizing and carbonitriding.

13. The grinding machine component of claim 12, wherein the grinding machine component formed into a grinding machine component by carburizing is accomplished by carburizing by a method selected from the group consisting of gas carburizing by placing in a carburizing gaseous atmosphere, pack carburizing by placing all the surfaces in contact with a solid compound, and combinations thereof.

14. The grinding machine component of claim 12, wherein the grinding machine component is formed into a grinding machine component by carbonitriding by dissociating ammonia into hydrogen and nitrogen.
